(19) United States
(12) Patent Application Publication
(10) Pub. No.: US 2003/0005177 A1
(43) Pub. Date: Jan. 2, 2003

(54) Loading files for a hardware device

(76) Inventors: Louis A. Duran, Hillsboro, OR (US); David Henkemeyer, Portland, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 09/916,946

(22) Filed: Jul. 26, 2001

Related U.S. Application Data
(60) Provisional application No. 60/301,920, filed on Jun. 30, 2001.

(51) Int. Cl. G06F 9/00; G06F 9/46

(52) U.S. Cl. 709/327

(57) ABSTRACT

A method for loading files for a hardware device. An operating system requests from a user a location of a first file component for the hardware device. The operating system receives input from the user that provides the location. A file at the location loads the first file component from the location and indicates to the operating system that the location contains a second file component for the hardware device. The operating system retrieves from the location the second file component for the hardware device.

### FIELD OF THE INVENTION

The invention relates to loading files for a hardware device in a computer system.

### BACKGROUND OF THE INVENTION

Plug-and-Play (PnP) is a hardware standard that enables a user to plug a new hardware device into a computer, and immediately be able to use the hardware device without the user having to perform complicated set-up tasks. See, for example, Plug and Play Design Specification for Institute of Electrical and Electronics Engineers (IEEE) 1394 version 1.0c, published Mar. 3, 1999; revisions May 1999. In order for PnP to work, the computer's operating system and the installed hardware device, among other things, must be PnP compliant. A network adapter, such as the AnyPoint Wireless Home Network Adapter Universal Serial Bus (USB) Model 1.6 Mbps, manufactured by Intel Corporation of Santa Clara, Calif., is an example of a PnP hardware device. See, e.g., Universal Serial Bus Specification Revision 2.0, issued Apr. 27, 2000. A Windows operation system, such as Windows 95 or a later version of Windows, manufactured by Microsoft Corporation of Redmond, Wash., is an example of a PnP compliant operating system.

Once a user physically installs a PnP network adapter, Windows detects the PnP network adapter and determines that it needs device driver files for the PnP network adapter. Windows requests user input for the location of an installation information file to load the device driver files. The installation information file is typically located on the compact disc (CD-ROM) supplied with the PnP network adapter. The user places the PnP network adapter's CD-ROM in the computer's CD-ROM drive and directs Windows to the CD-ROM drive. Windows accesses the CD-ROM, and the installation information file loads the device driver files.

Once the device driver files for the PnP network adapter are loaded, Windows requests user input for the location of networking files, such as protocol files, or file-sharing and printer-sharing files, which Windows will utilize when operating the PnP network adapter. The networking files are typically located on the Microsoft Windows operating system CD-ROM. Windows prompts the user to remove the PnP network adapter's CD-ROM and replace it with the Windows operating system CD-ROM. The user indicates completion of these tasks to Windows, and Windows loads the networking files.

The current method of installing a PnP network adapter, and in particular, loading networking files, is inconvenient and time-consuming because a user must deal with multiple CD-ROMs. Moreover, installation of the network adapter can fail if the user responds incorrectly to Windows' request for the location of networking files or the location of the installation information file that loads device driver files, does not have access to the Windows operating system CD-ROM, or provides a CD-ROM for the wrong version of Windows.

### BRIEF DESCRIPTION OF THE DRAWINGS

The invention is illustrated by way of example, and not by way of limitation, in the figures of the accompanying drawings in which like reference numerals refer to similar elements.

FIG. 1 is a block diagram of one embodiment of a computer system.

FIG. 2 is a flow diagram of a method of loading software for a hardware device.

FIG. 3 is a block diagram of a computer system that contains one embodiment of the invention.

### DETAILED DESCRIPTION

A method of loading files for a hardware device is described. In the following description, for purposes of explanation, numerous specific details are set forth in order to provide a thorough understanding of the invention. It will be apparent, however, to one skilled in the art that the invention can be practiced without these specific details. In other instances, structures and devices are shown in block diagram form in order to avoid obscuring the invention.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

In the method described herein for loading files for a hardware device, after discovering that the hardware device has been installed, an operating system requests user input for the location of an installation information file, so that the installation information file can load device driver files for the hardware device. In response to the operating system's request, the user directs the operating system to the root directory of a removable storage device supplied with the hardware device. From the user's perspective, the root directory of the removable storage device is the location of the installation information file that loads the device driver files, e.g., a CD-ROM. However, according to an embodiment of the invention, directing the operating system to the root directory of the removable storage device causes the operating system to access an installation information file that loads custom installation files. The custom installation files are collectively referred to as the Custom Installer, because they customize the installation of the hardware device by causing to be loaded device driver files and operating system files that are specific to the hardware device being installed and the operating system being used.

Loading the Custom Installer causes the operating system to function as though device driver files have been loaded, though in reality, the device driver files have not yet been loaded, and thus the hardware device cannot function. Once loaded, the Custom Installer is automatically launched. The Custom Installer loads the device driver files for the hardware device from the removable storage device supplied with the hardware device. The Custom Installer also modifies the operating system's registry to direct the operating system to the location of operating system files located on the removable storage device supplied with the hardware device. To eliminate the need to prompt for and require the user to provide a separate removable storage device during installation of the hardware device, the operating system files are stored on the same removable storage device supplied with the hardware device as the device driver files and custom installation files.

The Custom Installer causes the operating system to rediscover the hardware device, in which case the operating system normally, as it did when it initially discovered the hardware device, requests user input for the location of an installation information file to load the device driver files. Because the Custom Installer has loaded the device driver files, the Custom Installer prevents the operating system from requesting user input for the location of an installation information file to load the device driver files when the operating system rediscovers the hardware device. The operating system retrieves the operating system files from the removable storage device and loads them.

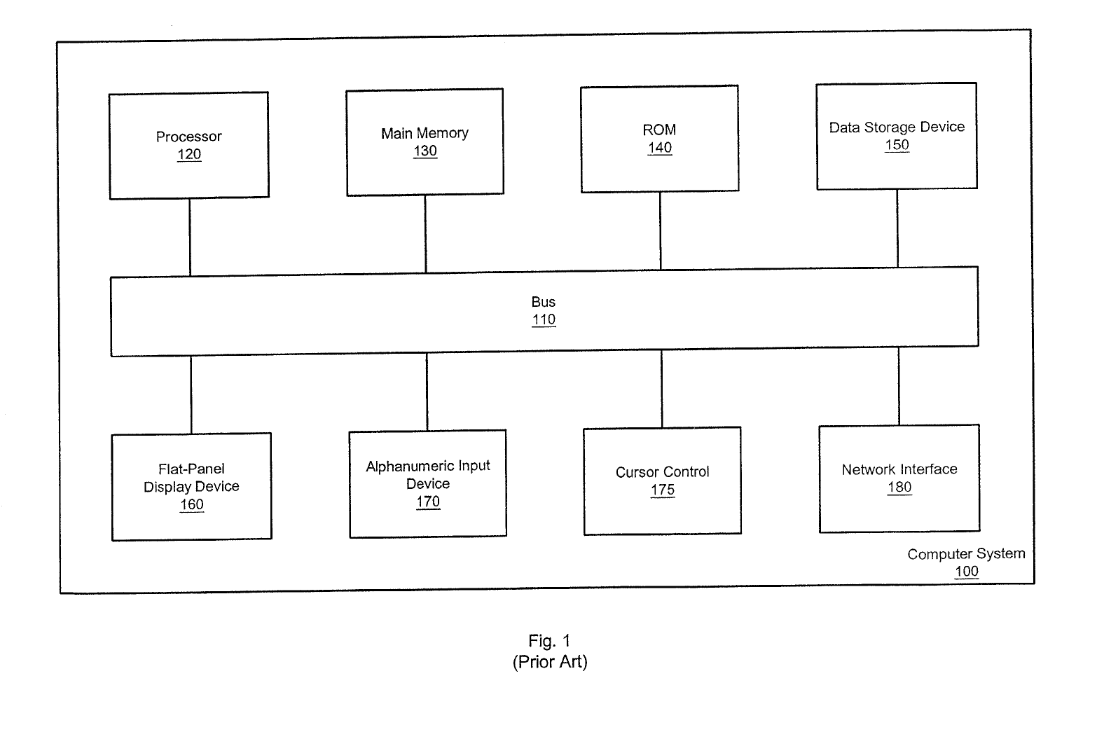

FIG. 1 is a block diagram of one embodiment of a computer system. The computer system is intended to represent a range of computer systems. Other computer systems can include more, fewer and/or different components.

Computer system 100 includes a bus 110 or other communication device to communicate information, and processor 120 coupled to bus 110 to process information. While computer system 100 is illustrated with a single processor, computer system 100 can include multiple processors and/or co-processors. Bus 110 encompasses all buses that may be present in a computer system, e.g., a Peripheral Component Interconnect (PCI) bus; a Personal Computer Memory Card International Association (PCMCIA) bus; a Universal Serial Bus (USB), etc. See, e.g., PCI Local Bus Specification Revision 2.2, released Dec. 18, 1998; PC Card Standard, March 1997 Release, First Printing; Universal Serial Bus Specification Revision 2.0, issued Apr. 27, 2000.

Computer system 100 further includes random access memory (RAM) or other dynamic storage device 130 (referred to as main memory), coupled to bus 110 to store information and instructions to be executed by processor 120. Main memory 130 also can be used to store temporary variables or other intermediate information while processor 120 is executing instructions. Computer system 100 also includes read-only memory (ROM) and/or other static storage device 140 coupled to bus 110 to store static information and instructions for processor 120. In addition, data storage device 150 is coupled to bus 110 to store information and instructions. Data storage device 150 may comprise a magnetic disk (e.g., a hard disk) or optical disc (e.g., a CD-ROM) and corresponding drive.

Computer system 100 may further comprise a flat-panel display device 160, such as a cathode ray tube (CRT) or liquid crystal display (LCD), to display information to a user. Alphanumeric input device 170, including alphanumeric and other keys, is typically coupled to bus 110 to communicate information and command selections to processor 120. Another type of user input device is cursor control 175, such as a mouse, a trackball, or cursor direction keys to communicate direction information and command selections to processor 120 and to control cursor movement on flat-panel display device 160. Computer system 100 further includes network interface 180 to provide access to a network, such as a local area network.

Instructions are provided to memory from a machine-accessible medium, or an external storage device accessible via a remote connection (e.g., over a network via network interface 180). A machine-accessible medium includes any mechanism that provides (i.e., stores and/or transmits) information in a form readable by a machine (e.g., a computer). For example, a machine-accessible medium includes RAM; ROM; magnetic or optical storage medium; flash memory devices; electrical, optical, acoustical or other form of propagated signals (e.g., carrier waves, infrared signals, digital signals); etc.

In alternative embodiments, hard-wired circuitry can be used in place of or in combination with software instructions to implement the present invention. Thus, the present invention is not limited to any specific combination of hardware circuitry and software instructions.

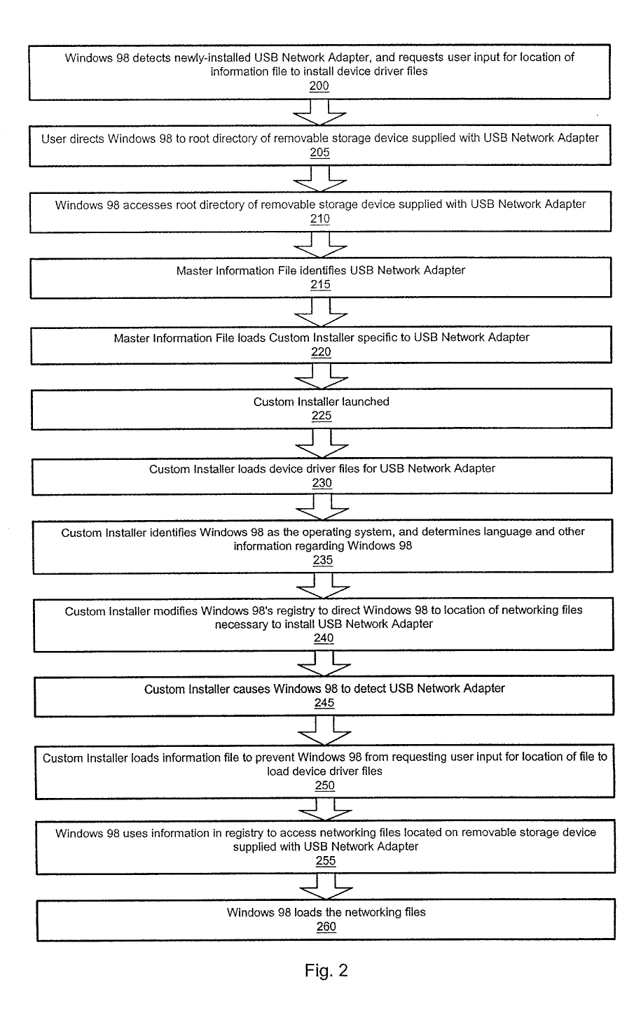

FIG. 2 is a flow diagram of a method of loading files during installation of a hardware device. For purposes of illustration and ease of explanation, FIG. 2 will be described in specific terms of a PnP device, specifically an AnyPoint Wireless Home Network Adapter USB Model 1.6 Mbps (herein referred to as the “USB Network Adapter”), newly installed in a computer that is running the PnP compliant Windows 98 operating system. However, the hardware device can be any internal or external device that requires files, software, etc., located on a removable storage device other than the removable storage device supplied with the hardware device, to be loaded during installation of the hardware device. For example, installation of the USB Network Adapter requires Windows 98 to load networking files located on the Windows 98 removable storage device. In addition, the operating system can be any operating system that requests user input for a location so that files can be loaded during the installation of a hardware device. For example, during the installation of the USB Network Adapter, Windows 98 requests user input for the location of an installation information file that loads device driver files for the USB Network Adapter.

At 200, Windows 98 detects the newly-installed USB Network Adapter plugged into computer system 100, and requests user input for the location of an installation information file, so that the installation information file can load the device driver files for the USB Network Adapter. An installation information file that loads device driver files for a hardware device is well-known to those of ordinary skill in the art, and thus will not be discussed further except as it pertains to the present invention. Although device driver files are described, the installation information file can be for loading files other than device driver files.

At 205, in response to Windows 98's request for the location of an installation information file to load the device driver files, the user directs Windows 98 to the root directory of the removable storage device supplied with the USB Network Adapter. The user can direct Windows 98 to the root directory of the removable storage device by entering the location of the removable storage device (such as a disk drive), or by entering a filename. From the user's perspective, the user has directed Windows 98 to the location of the installation information file that loads the device driver files. In reality, the user has directed Windows 98 to the location of an installation information file (herein referred to as the “Master Information File”) that loads custom installation files. The custom installation files are collectively referred to as the Custom Installer, because they customize the installation of the USB Network Adapter by loading device driver files, and causing operating system files to be loaded, which are specific to the USB Network Adapter and the Windows 98 operating system being used. Loading the Custom Installer causes Windows 98 to perform as though device driver files have been loaded. In reality, the device driver files have not yet been loaded, and thus the USB Network Adapter cannot function.

At 210, Windows 98 accesses the root directory of the removable storage device supplied with the USB Network Adapter. This causes the Master Information File to identify the USB Network Adapter at 215, so that the Master Information File can load the Custom Installer that is specific to the USB Network Adapter. In one embodiment, the Master Information File is capable of loading Custom Installers for different types of hardware devices, and thus must identify the particular hardware device being installed. At 220, the Master Information File loads the Custom Installer for the USB Network Adapter from the removable storage device. As discussed previously, loading the Custom Installer causes Windows 98 to function as though device driver files have been loaded. In one embodiment, when the Master Information File loads the Custom Installer, the Master Information File does not load any file components necessary to install the USB Network Adapter. However, the Master Information File could load file components, other than device driver files, that are necessary to install the USB Network Adapter. In addition, the Master Information File could load files that perform temporary tasks, or one-time setup or configuration tasks performed by the device driver files.

At 225, the Custom Installer is launched. At 230, the Custom Installer loads the device driver files for the USB Network Adapter from the removable storage device supplied with the USB Network Adapter. At 235, the Custom Installer identifies Windows 98 as the operating system running in computer system 100, and determines Windows 98's version, language (English, Japanese, etc.) and other information. In one embodiment, the Custom Installer can determine, based on the operating system being used, the operating system files an operating system will utilize to operate a hardware device.

At 240, the Custom Installer modifies Windows 98's registry to direct Windows 98 to the location of the Windows 98 files, specifically networking files, utilized to operate the USB Network Adapter, based on Windows 98's version, language and other information. An operating system registry is well-known to those of ordinary skill in the art, and thus will not be discussed further except as it pertains to the present invention.

This directs Windows 98 to a location at which Windows 98 files have been stored, to access the files without the user having to provide the Windows 98 removable storage device that otherwise contains the files. Although networking files are described, Windows 98 can be directed to the location of any files that Windows 98 will utilize to operate the USB Network Adapter. In one embodiment, Windows 98 is directed to the removable storage device supplied with the USB Network Adapter, in order to access the networking files. However, Windows 98 could be directed to a non-removable storage device on computer system 100, or to a remote location accessible via network interface 180.

At 245, the Custom Installer causes Windows 98 to detect the USB Network Adapter for a second time, the first time being when the USB Network Adapter was installed. In one embodiment, Windows 98 detects the USB Network Adapter automatically after the Custom Installer modifies the Windows 98 registry. In another embodiment, the Custom Installer causes computer system 100 to shut down and restart in order for Windows 98 to detect the USB Network Adapter. The Custom Installer could also prompt the user to shut down and restart computer system 100 in order for Windows 98 to detect the USB Network Adapter.

At 250, having previously loaded the device driver files for the USB Network Adapter, the Custom Installer loads an installation information file that prevents Windows 98 from, as Windows 98 did when it initially detected the USB Network Adapter, requesting user input for the location of an installation information file to load the device driver files. At 255, Windows 98 uses the information in its registry to access the Windows 98 networking files located on the removable storage device supplied with the USB Network Adapter. At 260, Windows 98 loads the networking files. Consequently, Windows 98 does not prompt the user for the Windows 98 removable storage device that also contains the networking files, so that when installing the USB Network Adapter, the user needs only the removable storage device supplied with the USB Network Adapter.

FIG. 2 describes the invention in terms of a method. However, one should also understand it to represent a machine-accessible medium having recorded, encoded or otherwise represented thereon instructions, routines, operations, control codes, or the like, that when executed by or otherwise utilized by the machine, cause the machine to perform the method as described above or other embodiments thereof that are within the scope of this disclosure.

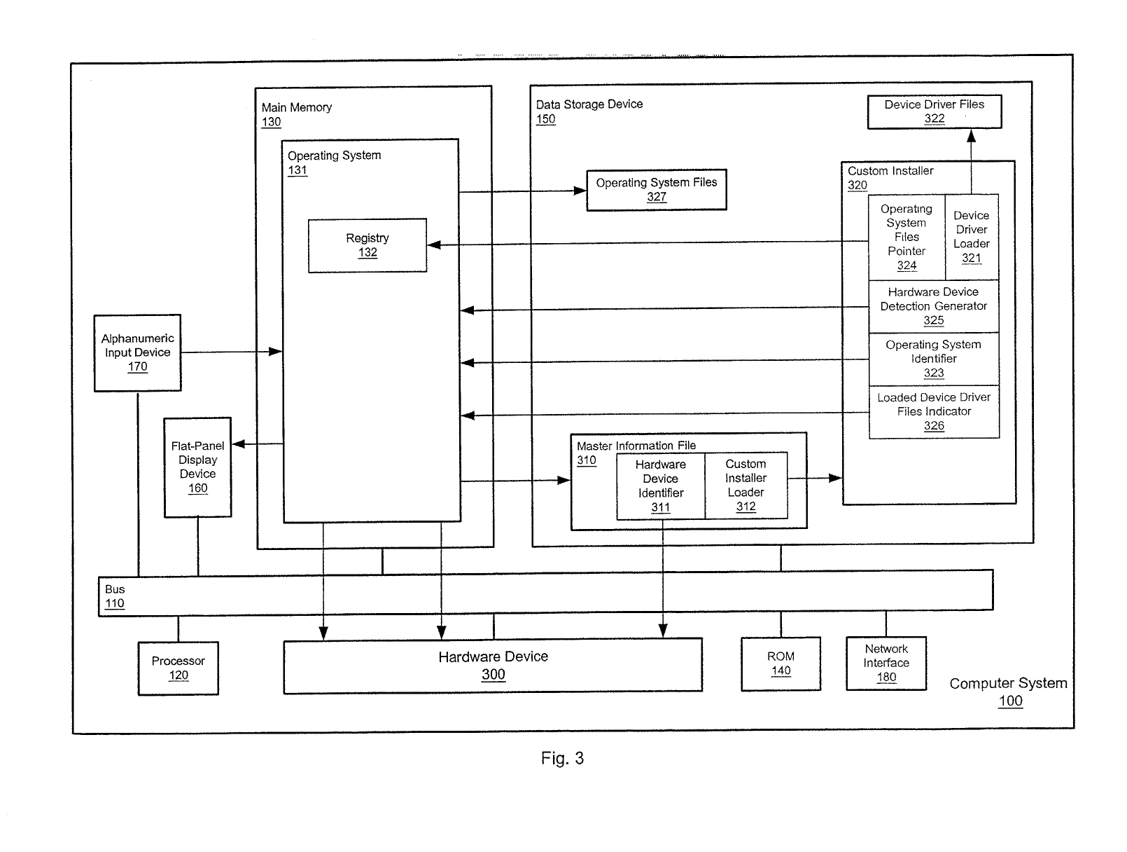

FIG. 3 is computer system 100 modified to include one embodiment of the invention. Computer system 100 contains a newly-installed hardware device 300. Once operating system 131 detects hardware device 300, operating system 131 requests via flat panel display device 160 user input for the location of an installation information file, so that the installation information file can load device driver files 322 for hardware device 300.

In response to the request, the user, via alphanumeric input device 170, provides to operating system 131 a location that directs operating system 131 to the root directory of a removable storage device (not shown) in data storage device 150. Instead of containing an installation information file to load device driver files 322, the root directory of the removable storage device contains Master Information File 310 that will load Custom Installer 320. Hardware device identifier 311 of Master Information File 310 identifies hardware device 300. Custom Installer loader 312 loads Custom Installer 320, which is specific to hardware device 300. Loading Custom Installer 320 causes operating system 131 to perform as though device driver files 322 are loaded.

Custom Installer 320 is launched. Device driver loader 321 loads device driver files 322 for hardware device 300. Operating system identifier 323 identifies various characteristics of operating system 131. Operating system files pointer 324 modifies operating system registry 132 to direct operating system 131 to the removable storage device in data storage device 150, so that operating system 131 can load operating system files 327 that operating system 131 will utilize, based on the characteristics of operating system 131, to operate hardware device 300.

Hardware device detection generator 325 causes operating system 131 to detect hardware device 300 again. Once operating system 131 detects hardware device 300, loaded device driver files indicator 326 loads an installation information file that prevents operating system 131 from requesting, as operating system 131 did when it initially detected hardware device 300, user input regarding the location of an installation information file to load device driver files 322 for hardware device 300. Operating system 131 uses the information in registry 132 to access the removable storage device in data storage device 150 and load operating system files 327, which operating system 131 will utilize to operate hardware device 300.

Although FIG. 3 shows main memory 130, data storage device 150, flat-panel display device 160 and alphanumeric input device 170 communicating directly, it should be understood that main memory 130, data storage device 150 and alphanumeric input device 170 communicate via bus 110. FIG. 3 shows direct communication between main memory 130, data storage device 150, flat-panel display device 160 and alphanumeric input device 170 merely for convenience.

In the foregoing specification, the invention has been described with reference to specific embodiments thereof. It will, however, be evident that various modifications and changes can be made thereto without departing from the broader spirit and scope of the invention. The specification and drawings are, accordingly, to be regarded in an illustrative rather than a restrictive sense.

What is claimed is:

1. A method comprising:
requesting from a user access to a repository of a first file component for a device;
receiving from the user input to provide access to the repository;
accessing at the repository a file that loads the first file component and identifies the repository as the location of a second file component for the device; and
retrieving from the repository the second file component for the device.

2. The method of claim 1, wherein the repository further comprises a removable storage device.

3. The method of claim 1, wherein the repository further comprises a non-removable storage device of a computer system.

4. The method of claim 1, wherein the repository further comprises a location on a computer network.

5. The method of claim 1, wherein the input to provide access to the repository further comprises a location of the repository.

6. The method of claim 1, wherein the input to provide access to the repository further comprises a filename.

7. A method of loading files for a hardware device in a computer system having an operating system that detects in a first instance the hardware device, comprising:
accessing a file of a first type at a location provided by a user in response to the operating system's request for user input for a file to load hardware device files for the hardware device, the file of the first type identifying the hardware device;
the file of the first type loading from the location files of a second type specific to the hardware device, the presence of the files of the second type causing the operating system to perform as though the hardware device files have been loaded;
launching the files of the second type;
the files of the second type installing the hardware device files from the location;
the files of the second type determining an identification of the operating system;
the files of the second type providing an indication to the operating system that at the location reside files of the operating system utilized, based on the identification of the operating system, to operate the hardware device;
the files of the second type causing the operating system to detect the hardware device in a second instance;
the files of the second type preventing the operating system from attempting to load hardware device files; and
installing the files of the operating system in response to the indication to the operating system that the files of the operating system reside at the location.

8. The method of claim 7, wherein the hardware device further comprises a Plug-and-Play network adapter.

9. The method of claim 8, wherein the Plug-and-Play network adapter further comprises a Universal Serial Bus (USB) network adapter.

10. The method of claim 8, wherein the Plug-and-Play network adapter further comprises a Personal Computer Memory Card International Association (PCMCIA) network adapter.

11. The method of claim 8, wherein the Plug-and-Play network adapter further comprises a Peripheral Component Interconnect (PCI) network adapter.

12. The method of claim 7, wherein the operating system further comprises a Plug-and-Play compliant operating system.

13. The method of claim 7, wherein the operating system request for user input for the file to load hardware device files further comprises a request for a location of the file to load the hardware device files.

14. The method of claim 7, wherein the hardware device files further comprise device driver files.

15. The method of claim 7, wherein the file of the first type further comprises an installation information file.

16. The method of claim 7, wherein the location further comprises a removable storage device.

17. The method of claim 7, wherein the presence of the files of the files of the second type is not sufficient for the hardware device to function in the computer system.

18. The method of claim 7, wherein the identification of the operating system further comprises the language and version of the operating system.

19. The method of claim 7, wherein the indication to the operating system that at the location resides the files of the operating system further comprises modifying a registry of the operating system.

20. The method of claim 7, wherein causing the operating system to detect the hardware device in a second instance further comprises shutting down and restarting the computer system.

21. An article of manufacture comprising a machine-accessible medium including thereon sequences of instructions that, when executed, cause a machine, to:
receive user input providing a location in response to a request by an operating system of the machine for a location of installation software to load files of a first type for a newly-installed hardware device detected in a first instance by the operating system;
access at the location installation software of a first type that identifies the hardware device;
receive from the installation software of the first type installation software of a second type specific to the hardware device;
cause the operating system, by indicating that the installation software of the second type has been loaded, to perform as though files of the first type have been loaded;
launch the installation software of the second type;
receive from the installation software of the second type the files of the first type;
receive from the installation software of the second type an identification of the language and version of the operating system;
receive from the installation software of the second type by modification of a registry of the operating system an indication that files of a second type specific to the language and version of the operating system reside at the location;
detect via the operating system the hardware device in a second instance;
prevent the operating system via the installation software of the second type from attempting installation of the files of the first type; and
receive from the operating system the files of the second type.

22. The article of claim 21, wherein the operating system further comprises a Plug-and-Play compliant operating system.

23. The article of claim 21, wherein the hardware device further comprises a Plug-and-Play network adapter.

24. The article of claim 21, wherein the location further comprises a removable storage device.

25. The article of claim 21, wherein the operating system files further comprise networking files.

26. An apparatus for use with a computer system comprising:
a master information file at a location provided by a user in response to a request by an operating system for a location of a file to load device driver files for a hardware device detected by the operating system, including a hardware device identifier to identify the hardware device, a custom installer loader to load a custom installer specific to the hardware device and cause the operating system to perform as though device driver files have been loaded; and
the custom installer, including a device driver loader to load the device driver files, an operating system identifier to identify the operating system, an operating system files pointer to modify a registry of the operating system in order to direct the operating system to the location to retrieve operating system files that the operating system utilizes to operate the hardware device, a hardware device detection generator to cause the operating system to detect the hardware device, and a loaded device driver files indicator to prevent the operating system from requesting from the user a location of the file to load the device driver files.

27. The article of claim 26, wherein the operating system further comprises a Plug-and-Play compliant operating system.

28. The article of claim 26, wherein the hardware device further comprises a Plug-and-Play network adapter.

29. The article of claim 26, wherein the location further comprises a removable storage device.

30. The article of claim 26, wherein the operating system files further comprise networking files.

31. An article comprising a machine-accessible medium including thereon sequences of instructions that, when executed, cause a machine, to:
request from a user access to a repository of a first file component for a device;
receive from the user input to provide access to the repository;
access at the repository a file that loads the first file component and identifies the repository as the location of a second file component for the device; and
retrieve from the repository the second file component for the device.

32. The method of claim 31, wherein the repository further comprises a removable storage device.

33. The method of claim 31, wherein the repository further comprises a non-removable storage device of a computer system.

34. The method of claim 31, wherein the repository further comprises a location on a computer network.

35. The method of claim 31, wherein the input to provide access to the repository further comprises a location of the repository.

36. The method of claim 31, wherein the input to provide access to the repository further comprises a filename.
